(19) United States
(12) Patent Application Publication
(10) Pub. No.: US 2006/0016502 A1
(43) Pub. Date: Jan. 26, 2006

(54) Umbilical filling

(76) Inventors: Sjur Kristion Lund, Halden (NO); Stian Karlsen, Halden (NO)

Correspondence Address: SOFER & HAROUN, L.L.P., Suite 910, 317 Madison Avenue, New York, NY, 10017, US

(21) Appl. No.: 11/127,789

(22) Filed: May 12, 2005

(30) Foreign Application Priority Data
May 28, 2004 (NO) 2004 2226

(51) Int. Cl. F16L 9/14

(52) U.S. Cl. 138/140

(57) ABSTRACT

The invention relates to an umbilical comprising at least two elongated elements chosen from a group consisting of steel tubes (1,2), electrical cables (4), optical fiber cables (3), and combinations thereof arranged side by side within a common outer sheath (5) along the length of the umbilical, where the interstices between the elongated elements (2,3,4) and the elongated elements (2,3,4) and the common sheath (5) are filled with a fluid filling material (6), which tempers to a higher viscosity after complete filling and adheres to the outer surface of the elements (2,3,4) and the inner surface of the common sheath (5).

### RELATED APPLICATIONS

The present invention is related to and claims the benefit of priority to Norwegian Patent Application No. 2004 2226, filed on May 28, 2005, the entirety of which is incorporated herein by reference.

### FIELD OF THE INVENTION

The present invention relates to an umbilical and a method of making an umbilical.

### BACKGROUND OF THE INVENTION

Umbilicals may function either as flowlines or risers. Umbilicals are composite structures capable of transporting hydraulic fluids, chemicals, electrical and optical signals and electric power. The conduit for chemical transport is usually placed in the center, while those for electrical signals and power and the hydraulic pipes are placed peripherally around the core element.

EP 0 177 475 discloses a pipeline cable for use under water and comprising a number of pipelines which follow helical lines in the cable, filler material around and between the pipelines, and a protective sheath surrounding the pipelines and filler material. The filler material is divided into four in the cross section and is of expanded PVC, thereby serving as heat insulation for the pipelines.

GB 1 210 206 discloses a multi-conduit underwater line, comprising a conduit or cable forming a core about which a plurality of further conduits are laid helically within a protective sheath. A non-foamed elastomeric filler is disposed between the core conduit or cable and the further conduits and a foamed elastomeric filler being disposed between the further conduits and the sheath.

GB 2 316 990 A discloses a subsea line, which comprises a number of fluid/gas conducting steel tubes and possibly other elongated elements e.g. electrical conductors and cables enclosed, and contains elongated sacrificial elements. Filler elements limit but do not eliminate free space all interstices being filled with bitumen or non-corrosive gel, in order to reduce the corrosion rate without preventing penetration of seawater.

EP 0 627 027 discloses an umbilical, comprising a core element, a plurality of conduits and/or cables situated outside the core, filler material around and between the conduits/cables and a protective sheath. The core element may be a metal tube for conducting a liquid. The metal tube may be used for injection of methanol into a drilling well. The material in the metal tubes is selected on the basis of high strength and good corrosion resistance. A preferred example of such materials is Super Duplex steel.

Super Duplex steel is regarded to be resistant against crevice corrosion in seawater up to temperatures of 25° C.

In umbilicals in warm areas such as Gulf of Mexico, Africa, Brazil etc. the temperature may rise above this critical limit.

In narrow crevices filled with a corrosive fluid, there is a risk for a type of local corrosion called crevice corrosion. Crevice corrosion occurs when the stainless steel's passive layer is destroyed through aggressive media and a concurrent depletion of oxygene inside the crevice. For this reason, crevice corrosion can be found in narrow gaps between the conduits in an umbilical.

A further problem in umbilicals used in deep water exists, when the umbilical contains electrical or optical cable. These elements limit the length of the umbilical as the tensile strength of the material is not high enough to take up the force resulting from the weight of the cable.

It has been proposed to solve the problem of crevice corrosion by extruding a layer of polymeric material to the Super Duplex steel tubes. Such a coating minimizes the risk for crevice corrosion, by avoiding direct seawater access to the steel tubes. This solution is very dependent on the quality of the plastic layer. If there are holes in the plastic layer, due to damage, crevice corrosion may still happen under the sheath close to the holes. Another drawback of this proposal is that the layers of plastic material may increase the outer diameter and the weight of the umbilical.

### OBJECTS AND SUMMARY OF THE INVENTION

According to the present invention an umbilical of the type described in the above introduction is provided, which umbilical is characterized in that the fluid filling material will temper to a higher viscosity after complete filling and will adhere to the outer surface of the elements and the inner surface of the common sheath.

The filing material must completely fill the interstices including small crevices. Silicone resin can be used by advantage as this material is capable of flowing into small gaps when exposed to high pressure and/or high temperature. Silicone resin adheres to metal surfaces as well as to plastic surfaces as it can be tempered to higher viscosity after complete filling. The electrical and/or optical cables will then be fixed to the surface of the stainless steel conduits by the silicone resin over the total length of the umbilical. In consequence thereof the stress may be transferred to stronger elements of the umbilical and it is possible to achieve greater submarine depths.

The filling material may contain hollow beads of glass or plastic material in order to reduce the weight of the umbilical.

In accordance with the present invention, there is also provided a method of making an umbilical which is characterized in that a definite length of the umbilical is prepared, that a first end of the umbilical is connected to a supply of a fluid filling material and that the filling material is filled into the interstices between the elements and the elements and the common sheath by way of pressure and/or suction.

### BRIEF DESCRIPTION OF THE DRAWINGS

In the following a preferred embodiment of the invention will be described with reference to the appended drawings where:

FIG. 1 is a schematic transverse sectional view of an umbilical showing its construction.

FIG. 2 is a schematic view of a device for filling the umbilical according to the invention.

### DETAILED DESCRIPTION

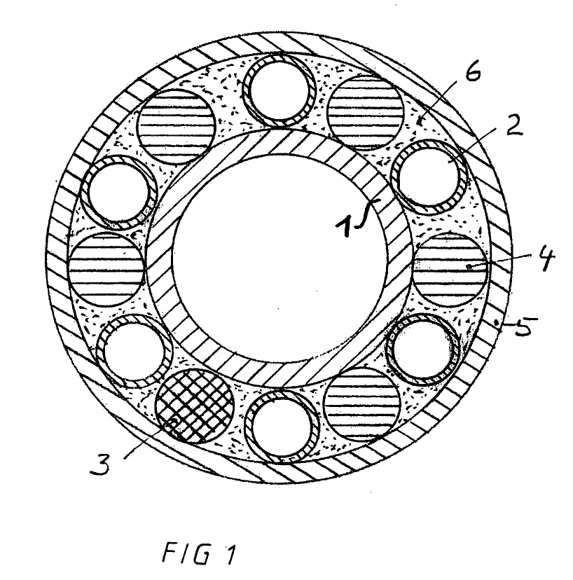

FIG. 1 shows an embodiment of subsea steel tube umbilical with a core 1 formed by an inner stainless steel tube, which may be a fluid conduit. The steel tube is by preference made of Super Duplex steel. Several hydraulic tubes 2 made of Super Duplex steel, too, are stranded to the inner core 1 as well as an optical fibre cable 3 and five electrical cables 4.

An outer sheath 5 of plastic material surrounds the layer of conduits 2 and cables 3 and 4. The sheath 5 is an extruded sheath of polyethylene.

The umbilical may include filler elements (not shown) limiting the free space between the conduits 2 and the cables 3 and 4.

The interstices between the inner core 1, the sheath 5 and the elements 2, 3 and 4 are completely filed with a filling material 6, preferably with silicone resin. The filling material has a low viscosity such as to fill the smallest spaces between the elements 2, 3 and 4 and the inner core 1 and the sheath 5.

The filling material adheres to the surfaces of the inner core 1, the elements 2, 3 and 4 and the inner surface of the sheath 5.

The filling material may contain hollow beads of plastic material or glass. Thereby the weight of the umbilical is reduced.

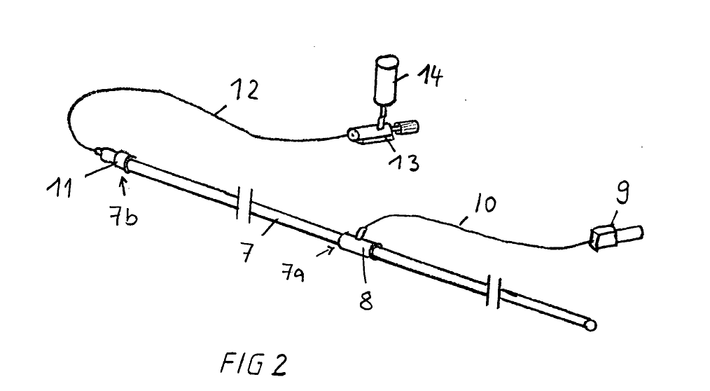

The FIG. 2 shows schematically an apparatus for filling the umbilical with filling material.

A first end 7a of an umbilical 7 is connected in a fluid-tight manner to a chamber 8, which is connected to a vacuum pump 9 via a conduit 10.

The opposed end 7b of the umbilical is connected in a fluid-tight manner, too, with a pressure chamber 11, which is connected, via a conduit 12 with a pump 13. The filling material is in a storage container 14. The filling material is fed from the storage container 14 into the umbilical 7 by action of the vacuum pump 9 and the piston pump 13.

1. An Umbilical, comprising:
at least two elongated elements chosen from a group consisting of steel tubes, electrical cables, optical fiber cables, and combinations thereof arranged side by side within a common outer sheath along the length of the umbilical, the interstices between the elongated elements and the elongated elements and the common sheath being filled with a fluid filling material, wherein the fluid filling material tempers to a higher viscosity after complete filling and adheres to the outer surface of the elements and the inner surface of the common sheath.

2. Umbilical according to claim 1, wherein the filling material is silicone.

3. Umbilical according to claim 1, wherein the filling material contains hollow elements to improve buoyancy of the umbilical.

4. Umbilical according to claim 3, wherein the hollow elements are beads made of glass or plastic material.

5. Method of making an umbilical, comprising the steps of:
choosing at least two elongated elements from a group consisting of steel tubes, electrical cables, optical fiber cables and combinations thereof
arranging said two elongated elements side by side within a common outer sheath along the length of the umbilical, wherein a definite length of the umbilical is prepared, that a first end of the umbilical is connected to a supply of a fluid filling material and that the filling material is filled into the interstices between the elements as well as between the elements and the common sheath by way of pressure and/or suction.

6. Method according to claim 5, wherein the filling material tempers to a higher viscosity and adheres to the outer surface of the elements and the inner surface of the common sheath.

7. Method according to claim 5, wherein the filling material is silicone resin.

8. Method according to claim 5, wherein the filling material is pressed into the interstices from one end of the umbilical.

9. Method according to claim 5, wherein a definite length of the common sheath is removed from the second end of the umbilical which is opposed to the first end, and that a vacuum pump is attached to the second end of the umbilical.
